(19) United States
(12) Patent Application Publication
(10) Pub. No.: US 2026/0233197 A1
(43) Pub. Date: Aug. 13, 2026

(54) THERMOCHEMICAL SALT ENCAPSULATED HYDROGEL FOR THERMAL MANAGEMENT AND DEHUMIDIFICATION

(71) Applicant: Georgia Tech Research Corporation, Atlanta, GA (US)

(72) Inventors: Yuhang Hu, Atlanta, GA (US); Jiehao Chen, Atlanta, GA (US)

(21) Appl. No.: 19/534,080

(22) Filed: Feb. 9, 2026

Related U.S. Application Data
(60) Provisional application No. 63/755,436, filed on Feb. 7, 2025.

(51) Int. Cl. B01J 20/28; B01J 20/32

(52) U.S. Cl. CPC B01J 20/28004; B01J 20/3204; B01J 20/3236

(57) ABSTRACT

Adsorbent compositions presented herein include a porous hydrogel, and one or more energy storage compounds contained within the hydrogel, wherein the one or more energy storage compounds are at least 50 wt % of the adsorbent composition on a dry weight basis. Adsorbent compositions presented herein may be prepared by preparing an adsorbent precursor solution comprising one or more hydrogel precursors and one or more energy storage compounds, drop casting the adsorbent precursor solution into a density gradient suspension to form adsorbent precursor solution beads suspended therein, and subjecting the suspended adsorbent precursor solution beads to irradiation to form the adsorbent composition.

### CROSS REFERENCE TO RELATED APPLICATION

This application claims the benefit of U.S. Provisional Application No. 63/755,436, file on Feb. 7, 2025, the entire contents of which are incorporated by reference herein.

### FIELD OF THE INVENTION

The present disclosure generally relates to thermochemical salt encapsulated (TCSE) hydrogels. More specifically, present disclosure generally relates to hydrogel compositions and thermochemical energy storage or harvesting systems (TCES) using said hydrogel compositions.

### BACKGROUND

Thermochemical energy sources are emerging as energy-efficient alternatives to primary energy sources like electricity and fossil fuel. Systems utilizing thermochemical energy storage (TCES) offer significant potential for conserving energy and reducing greenhouse gas emissions. In recent years, diverse applications have been developed based on TCES materials that leverage water adsorption-desorption processes. Examples include thermal management systems for buildings (cooling and heating), humidity management systems (dehumidification), and air water harvesting systems (atmospheric water generation or AWG). The key advantage of these systems lies in their high energy density and the ability to store or release thermal energy through chemical bonds within the energy storage medium. Notably, Additionally, TCES materials are far more cost-effective, ranging from $0.2 to $3.7 per kilogram, compared to $40 to $70 per kilogram for lithium-ion batteries, making TCES an economically attractive option. The sustainable and efficient nature of TCES presents an ideal solution for replacing conventional energy sources and energy storage systems, offering opportunities in energy efficient thermal and humidity management, or AWG system design. Their alignment with current market demands highlights their potential to revolutionize energy storage and application systems.

Despite their potential, TCES systems face several challenges that hinder broader adoption. Key issues include improving energy density (both volumetric and gravimetric), material stability, charging and discharging performance, and production cost. First, due to the low thermal conductivity of most TCES materials, it requires a high heat exchange surface-to-volume ratio, which significantly increase the size and weight of adsorption chambers-ultimately reducing the system's overall energy efficiency to less than one-third of the theoretical TCES energy density. Another critical hurdle is the reliance on active heating to extremely high temperatures (>200° C.) for the adsorbent regeneration, which make household applications less feasible. Additionally, the stability of the salt bed poses a significant problem, particularly in salt-water adsorption systems during scale-up. After absorbing water vapor, salt crystals can become deliquescent, leading to aggregation and blockage of the water vapor pathways. These blockages reduce the effective surface area for water adsorption/desorption, thereby diminishing the energy release rate. Attempts to mitigate this issue by encapsulating hygroscopic salt within inert and porous minerals such as silica gel, zeolite, and vermiculite have shown limited success. Challenges such as low salt loading (<20% by weight), limited water intake ratio (<1 for typical zeolites), poor mechanical integrity, and rigid manufacturing processes persist. Hydration-related volumetric expansion of salt can further lead to fractures in these brittle minerals, complicating their application and reducing long term durability.

### SUMMARY OF THE INVENTION

Various aspects of the present disclosure are directed to adsorbent compositions that exhibit properties that render such adsorbent compositions particularly suitable for applications where thermochemical energy is stored or released. Examples include, but are not limited to, thermal management, humidity management, and air water generation applications. Adsorbent compositions according to various aspects of the disclosure may comprise numerous compounds that, when combined, yield adsorbent compositions which exhibit exceptional water adsorption, extremely high salt capacity, and long-term cyclic stability. Generally, adsorbent compositions according to various aspects of the disclosure comprise, consist essentially of, or consist of a hydrogel and one or more salts. Adsorbent compositions according to various aspects of the disclosure generally include a nonporous outer shell and an internally porous bulk hydrogel phase within which one or more thermal energy storage compounds, such as salts, is embedded. Adsorbent compositions according to various aspects of the disclosure exhibit exceptionally high loadings of thermal energy storage compounds. For example, adsorbent compositions according to various aspects of the disclosure have salt loadings ranging from 60 to 90% relative to the total dry weight of the adsorbent composition. The adsorbent compositions exhibit very high energy densities, extended cyclic performances and stabilities, and efficient solvent transport properties.

Adsorbent compositions according to various aspects of the disclosure address various shortcomings and limitations in prior salt-based thermal-chemical energy storage (TCES) materials. Prior TCES materials generally are made of a hygroscopic salt embedded in a porous mineral medium such as vermiculate, zeolite, and silica gel. A good TCES material system should achieve a good balance among the energy density, discharging profile tunability, as well as cyclic stability. High energy density requires high salt content; while charging and discharging profile control requires efficient vapor and solvent transport throughout the storage material. The cyclic stability of TCES materials involves complicated considerations including not only the chemical stability of the material but also the mechanical resilience of the hosting structure-under repeated thermal cycling, the TCES material will undergo significant volumetric change and can lead to mechanical fractures or collapsing. Existing TCES systems typically suffer from one or more of the following drawbacks. For example, the salt loading in existing TCES systems is limited by physical miscibility of salt crystal and porous mineral skeleton. Additionally, the rigid mineral host material in existing TCES systems restricts the water adsorption process and concurrent volumetric expansion, slowing hydration and dehydration kinetics. Also, existing TCES systems often suffer from mechanical fatigue under repeated volumetric expansion/shrinkage during discharging/charging processes. Furthermore, bead or pellet fabrication methods for existing TCES systems provide limited control over internal structure and salt distribution.

Various non-limiting aspects of the disclosure can be described as follows.

In some instances, a first aspect of the disclosure may be described as an adsorbent composition comprising, consisting essentially of, or consisting of a porous hydrogel, and one or more energy storage compounds contained within the hydrogel, wherein the one or more energy storage compounds are at least 50 wt % of the adsorbent composition on a dry weight basis.

In some instances, a second aspect of the disclosure may be described as an adsorbent composition according to the first aspect, wherein the one or more energy storage compounds are 60 to 90 wt % of the adsorbent composition on a dry weight basis.

In some instances, a third aspect of the disclosure may be described as an adsorbent composition according to the first or second aspect, wherein the adsorbent composition is in a hydrated form.

In some instances, a fourth aspect of the disclosure may be described as an adsorbent composition according to any one of the first through third aspects, wherein the adsorbent composition is convertible to a dehydrated form by heating at a temperature of less than 200° C.

In some instances, a fifth aspect of the disclosure may be described as an adsorbent composition according to any one of the first through third aspects, wherein the adsorbent composition is convertible to a dehydrated form by heating at a temperature of less than 100° C.

In some instances, a sixth aspect of the disclosure may be described as an adsorbent composition according to any one of the first through fifth aspects, further comprising a nonporous outer hydrogel shell encapsulating the porous hydrogel.

In some instances, a seventh aspect of the disclosure may be described as an adsorbent composition according to any one of the first through sixth aspects, wherein the one or more energy storage compounds comprise a salt.

In some instances, an eighth aspect of the disclosure may be described as an adsorbent composition according to the seventh aspect, wherein the salt is a chloride salt, a bromide salt, a sulfate salt, a nitrate salt, or an acetate salt.

In some instances, a ninth aspect of the disclosure may be described as an adsorbent composition according to any one of the first through eighth aspects, wherein the porous hydrogel is a natural hydrogel.

In some instances, a tenth aspect of the disclosure may be described as an adsorbent composition according to any one of the first through eighth aspects, wherein the porous hydrogel is a synthetic hydrogel.

In some instances, an eleventh aspect of the disclosure may be described as an adsorbent composition according to any one of the first through tenth aspects, wherein the adsorbent composition has an aspect ratio ranging from about 1 to about 2.

In some instances, a twelfth aspect of the disclosure may be described as a thermochemical adsorption cooling system (TACS) comprising an adsorbent composition according to any one of the first through eleventh aspects.

In some instances, a thirteenth aspect of the disclosure may be described as a thermochemical energy storage (TCES) system comprising an adsorbent composition according to any one of the first through eleventh aspects.

In some instances, a fourteenth aspect of the disclosure may be described as a method of making an adsorbent composition comprising preparing an adsorbent precursor solution comprising one or more hydrogel precursors and one or more energy storage compounds, drop casting the adsorbent precursor solution into a density gradient suspension to form adsorbent precursor solution beads suspended therein, and polymerizing the suspended adsorbent precursor solution beads to form the adsorbent composition.

In some instances, a fifteenth aspect of the disclosure may be described as a method of making an adsorbent composition according to the fourteenth aspect, wherein the adsorbent precursor solution is further prepared with a crosslinker.

In some instances, a sixteenth aspect of the disclosure may be described as a method of making an adsorbent composition according to the fourteenth or fifteenth aspect, wherein the adsorbent precursor solution is prepared to have a density ranging from about 1.0 to about 1.3 g/mL, from about 1.1 to about 1.3 g/mL, from about 1.2 to about 1.3 g/mL, or 1.2 to about 1.25 g/mL.

In some instances, a seventeenth aspect of the disclosure may be described as a method of making an adsorbent composition according to any one of the fourteenth through sixteenth aspects, wherein the polymerization is initiated by a process comprising, but not limited to, light irradiation, thermal initiation, and redox initiation.

In some instances, an eighteenth aspect of the disclosure may be described as a method of making an adsorbent composition according to any one of the fourteenth through seventeenth aspects, wherein the density gradient suspension has a density gradient ranging from about 0.7 g/ml to about 1.4 g/ml.

In some instances, a nineteenth aspect of the disclosure may be described as a method of making an adsorbent composition according to any one of the fourteenth through seventeenth aspects, wherein the density gradient suspension has a density gradient ranging from about 0.7 g/ml to about 1.3 g/ml.

In some instances, a twentieth aspect of the disclosure may be described as a method of making an adsorbent composition according to any one of the fourteenth through nineteenth aspects, wherein the density gradient suspension comprises surfactant-based micelles.

In some instances, a twenty-first aspect of the disclosure may be described as a method of making an adsorbent composition according to the twentieth aspect, further comprising removing surfactant-based micelles from the adsorbent composition.

In some instances, a twenty-second aspect of the disclosure may be described as an adsorbent composition according to any one of the first through eleventh aspects prepared by a method according to any one of the fourteenth through twenty-first aspects.

### BRIEF DESCRIPTION OF THE DRAWINGS

In order that the present disclosure may be readily understood, aspects of the vial adapter are illustrated by way of examples in the accompanying drawings, in which like parts are referred to with like reference numerals throughout.

FIG. 1 is an illustration of energy releasing and storage cycles of thermochemical salt encapsulated hydrogels according to various aspects of the disclosure in thermochemical energy driven systems.

FIG. 2 is an illustration of an experimental set-up for synthesizing thermochemical salt encapsulated hydrogels according to various aspects of the disclosure.

FIG. 3 is a series of images showing a thermochemical salt encapsulated hydrogel according to various aspects of the disclosure, in the form of a bead, when hydrated by water vapor to equilibrium at different humidity levels. (dry, 30% RH, 50% RH, and 75% RH). The results represent the extreme water intake capability of salt incapsulated hydrogels according to various aspects of the disclosure.

FIG. 4 is an image showing the porosity of a thermochemical salt encapsulated hydrogel according to various aspects of the disclosure.

FIG. 5 is a graph showing the degree of water vapor sorption of a thermochemical salt encapsulated hydrogel according to various aspects of the disclosure at varying humidity levels.

FIG. 6 is a graph showing the drying rate over time, indicating efficient regeneration of thermochemical salt encapsulated hydrogels according to the disclosure with complete recovery possible within one hour at 65° C., a temperature easily achievable with solar heat.

FIG. 7 is a graph of Differential Scanning calorimetry (DSC) testing of hydrogel beads under regeneration.

FIG. 8 is a graph illustrating the effect of hydrogel precursor salt concentration and regeneration temperature on salt loading in exemplary charged TCSE hydrogel beads according to various aspects of the disclosure.

FIG. 9 is a graph illustrating swelling kinetics of exemplary TCSE hydrogel beads according to various aspects of the disclosure under different relative humidities at 40° C.

FIG. 10 is a graph illustrating swelling kinetics of exemplary TCSE hydrogel beads according to various aspects of the disclosure under a relative humidity of 75% RH at different temperatures.

FIG. 11 is a graph illustrating swelling kinetics of different exemplary TCSE hydrogel beads according to various aspects of the disclosure.

FIG. 12 is a Scanning Electron Microscopy (SEM) image of an exemplary TCSE hydrogel beads produced in the absence of a surfactant-based micelle.

FIG. 13 is an Energy-Dispersive X-ray Spectroscopy (EDS) image showing calcium distribution in an exemplary TCSE hydrogel beads according to various aspects of the disclosure.

FIG. 14 is a graph comparing swelling kinetics of TCSE hydrogel beads with and without internal porosity.

FIG. 15 is a graph comparing the weight change of an exemplary TCSE hydrogel beads under repeated hydration-dehydration cycles.

FIG. 16 is a graph showing the converted swelling ratio of an exemplary TCSE hydrogel beads under repeated hydration-dehydration cycles, which demonstrates stable operation-regeneration of the thermochemical salt encapsulated hydrogels according to the disclosure over 10 cycles.

FIG. 17 is a graph showing the energy density of an exemplary TCSE hydrogel beads under repeated hydration-dehydration cycles, which demonstrates stable operation-regeneration of the thermochemical salt encapsulated hydrogels according to the disclosure over 10 cycles.

FIG. 18 is a graph comparing the energy of an exemplary TCSE hydrogel beads under repeated hydration-dehydration cycles at 75% and 100% RH.

FIG. 19 is a graph comparing the energy of an exemplary TCSE hydrogel beads and a micronized version thereof under repeated hydration-dehydration cycles at 75% RH.

### DETAILED DESCRIPTION

The following description of the embodiments is merely exemplary in nature and is in no way intended to limit the subject matter of the present disclosure, their application, or uses.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

As used herein, the terms “dry weight” and “dry weigh basis” of a material means the weight of the material in which the presence of water (H₂O) (and/or other solvents) is neglected for the purposes of the calculation. Water (and/or other solvents) is neglected because addition and removal of water (and/or other solvents) are common processing steps, and also happen naturally through evaporation and condensation; it is frequently useful to express compositions on a dry basis to remove these effects.

Various aspects of the present disclosure are directed to adsorbent compositions that exhibit properties that render such adsorbent compositions particularly suitable for applications where thermochemical energy is stored or released. Examples include, but are not limited to, thermal management, humidity management, and air water generation applications. Adsorbent compositions according to various aspects of the disclosure may comprise numerous compounds that, when combined, yield adsorbent compositions which exhibit exceptional water adsorption, extremely high salt capacity, and long-term cyclic stability. Generally, adsorbent compositions according to various aspects of the disclosure comprise, consist essentially of, or consist of a hydrogel and one or more salts. Various hydrogels may be used in adsorbent compositions according to the disclosure. Hydrogels are crosslinked polymer chains with porous three-dimensional (3D) network structures, which can absorb relatively large amounts of water or water vapor due to the presence of hydrophilic groups (for example, —NH₂, —COOH, —OH, —CONH₂, —CONH, and —SO₃H). By designing specific chemical compositions and incorporating various functional molecules, the hydrogel's mechanical, thermal, and chemical property can be precisely tuned for optimized thermochemical performance as well as economic advantages.

In some instances, adsorbent compositions according to the disclosure may incorporate a “natural hydrogel”, that is, a hydrogel derived from one or more naturally occurring polymers or monomers of said naturally occurring polymers. Exemplary natural hydrogels include, but are not limited to, hydrogels derived from protein-based sources such as, for example, collagen, elastin, fibrin, gelatin, silk fibroin and so on. Exemplary natural hydrogels also include, but are not limited to, hydrogels derived from polysaccharide-based sources such as, for example, glycosaminoglycans, alginate, cellulose, chitosan, chondroitin, hyaluronic acid, and so on. In some instances, hydrogels according to the disclosure can be a copolymeric or multiblock polymeric hydrogel made from more than one naturally occurring polymer or monomers thereof.

In some instances, adsorbent compositions according to the disclosure may incorporate a “synthetic hydrogel”, that is, a hydrogel derived from one or more synthetically prepared polymers or monomers of said synthetically prepared polymers. Exemplary synthetic hydrogels include but are not limited to hydrogels derived from synthetic monomers (such as, acrylic acids (AAs), acrylamides (AAMs), polyvinyl alcohols (PVAs), polyethylene glycols (PEGs), polyethylene oxides (PEOs), N-isopropyl acrylamides (NIPAMs), 2-hydroxyethyl methacrylates (HEMAs), methyl acrylamide (MAA), t-butyl acrylamide (TBAA), 2-hydroxyethyl acrylamide (HEAA), 2-acrylamido-2-methylpropane sulfonic acid (AMPS) and so on) and crosslinkers (such as N,N′-methylenebisacrylamide, poly(ethylene glycol) diacrylate, glutaraldehyde, and so on) through synthetic processes such as radical polymerization, condensation polymerization, or ring opening polymerization. In some instances, the hydrogel is synthesized with the aid of a polymerization initiator. For example, commonly used initiators for radical initiated polymerization include, but not limited to, ammonium persulfate (APS, thermal initiator), 2-hydroxy-4′-(2-hydroxyethoxy)-2-methylpropiophenone (I-2959, 365 nm UV initiator).

In some instances, hydrogels according to the disclosure can be copolymeric or multiblock polymeric hydrogels made from one or more naturally occurring polymers (or monomers of said naturally occurring polymers) and one or more synthetically prepared polymers (or monomers of said synthetically prepared polymers).

In some instances, the use of polymers or monomeric precursors thereof that are amenable to polymerization and polymeric crosslinking using corresponding initiation stimulation, with or without the use of a polymerization catalyst, may be preferred.

Various thermal energy storage compounds may be incorporated into adsorbent compositions according to various aspects of the disclosure. The energy storage compounds incorporated in the hydrogels are selected based on features such as low critical humidity (<30% RH under ambient temperature and pressure), high solubility (>30% wt. in saturated solution), and high hydration/dissolution enthalpy (>1500 kJ/kg for pure-formed salts) which is typically an ionic compound that can hydrate or dissociate when absorbs water. The specific ionic compounds (or referred as salt) incorporated can be segregated based on its exothermic or endothermic property during dissolution. Exemplary salts include, but are not limited to chloride salts, bromide salts, sulfate salts, nitrate salts, acetate salts and so on. Exemplary exothermic salts include, but are not limited to, lithium chloride, sodium chloride, barium chloride, magnesium chloride, calcium chloride, strontium chloride, lithium bromide, sodium bromide, barium bromide, magnesium bromide, calcium bromide, strontium bromide, sodium sulfate, magnesium sulfate, calcium sulfate, sodium nitrate, potassium acetate, or any hydrate of any of the foregoing, or any combination of the foregoing. Exemplary endothermic salts include, but are not limited to, ammonium nitrate, ammonium chloride, potassium chloride, potassium bromide, sodium malonate, sodium succinate, or any hydrate of any of the foregoing, or any combination of the foregoing. Generally, any salt that exhibits deliquescent properties (i.e., a salt that absorbs water) may be used.

Adsorbent compositions according to various aspects of the disclosure may be provided in various shapes and/or sizes. In some instances, adsorbent compositions according to the disclosure may be in the form of a three-dimensional structure such as spherical or cuboidal. In some instances, adsorbent compositions according to the disclosure may be in the form of a film, a sheet, a coating, a mesh, or similarly dimensioned porous structures. In some instances, adsorbent compositions according to the disclosure may exhibit uniform or relatively uniform shapes and dimensions. In some instances, adsorbent compositions according to the disclosure may be in the form of irregularly shaped granules. In some instances, adsorbent compositions according to the disclosure may exhibit aspect ratios (width/length) ranging from about 1 to about 10, alternatively from about 1 to about 8, alternatively from about 1 to about 6, alternatively from about 1 to about 4, and alternatively from about 1 to about 2. In some instances, adsorbent compositions according to the disclosure may exhibit a longest dimension of less than 10 millimeters (mm). In some instances, adsorbent compositions according to the disclosure may exhibit a longest dimension ranging from about 0.01 micrometers (μm) to about 10 mm, alternatively from about 0.1 μm to about 8 mm, alternatively from about 0.2 μm to about 6 mm, alternatively from about 0.4 μm to about 4 mm, alternatively from about 0.6 μm to about 2 mm, and alternatively from about 0.8 μm to about 1.5 mm.

Adsorbent compositions according to various aspects of the disclosure generally include a nonporous outer hydrogel shell and an internally porous bulk phase within which the thermal energy storage compound is embedded.

Adsorbent compositions according to various aspects of the disclosure may have varying amounts of the polymers and one or more thermal energy storage compounds, such as one or more salts as described elsewhere herein. In some instances, adsorbent compositions according to the disclosure may be prepared to have a hydrogel-to-salt(s) weight:weight ratio (prior to the measurement, the sample is dried at 65° C., 15 RH % for 2 hours) ranging from about 75:25 to about 20:80. In some instances, adsorbent compositions according to the disclosure may be prepared to have a hydrogel-to-salt(s) weight:weight ratio ranging from about 90:10 to about 10:90, alternatively from about 85:15 to about 15:85, alternatively from about 80:20 to about 20:80, and alternatively from about 60:40 to about 40:60. In some instances, adsorbent compositions according to the disclosure may be prepared to have a salt(s) content of at least 50 wt %, relative to the weight of the adsorbent composition on a dry weight basis. In some instances, adsorbent compositions according to the disclosure may be prepared to have a salt(s) content of at least 60 wt %, relative to the weight of the adsorbent composition on a dry weight basis. In some instances, adsorbent compositions according to the disclosure may be prepared to have a salt(s) content of at least at least 60 wt % and up to 90 wt %, relative to the weight of the adsorbent composition on a dry weight basis.

In some instances, adsorbent compositions according to various aspects of the disclosure are provided in a dehydrated form. For example, adsorbent compositions according to the disclosure may have a water content of less than 5 wt %, preferably less than 4 wt %, more preferably less than 3 wt %, more preferably less than 2 wt %, more preferably less than 1 wt %, more preferably less than 0.5 wt %, and more preferably less than 0.1 wt %.

In some instances, adsorbent compositions according to various aspects of the disclosure are provided in a partially hydrated form. For example, adsorbent compositions according to the disclosure may have a water content ranging between about 5 and about 20 wt %, preferably between about 5 and about 15 wt %, and more preferably between about 5 and about 10 wt %.

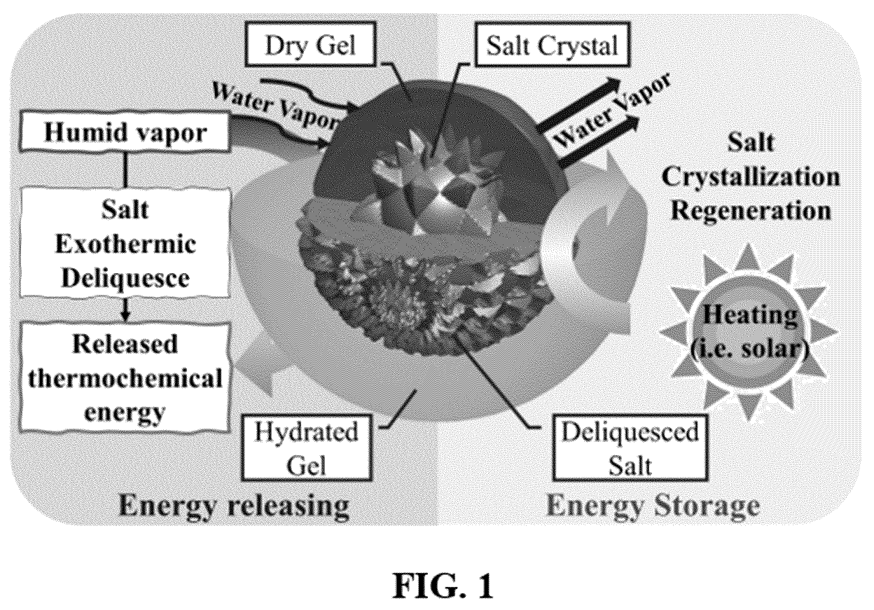

FIG. 1 is a schematic illustration that shows the working cycle of thermochemical salt encapsulated hydrogels according to various aspects of the disclosure in applications such as thermal management, humidity management and air-water generation systems. The hydrogel compositions disclosed herein exhibit exceptional water adsorption under varying levels of water vapor saturation, extremely high salt capacity and energy density, and long-term cyclic stability. When vapor is absorbed into the hydrogel compositions, it initiates a rapid hydration-dissolution reaction. Two types of energies can be harvested through this reaction. First, reaction heat released from the hydrogel beads can be utilized for heating applications. Second, the continuous vapor adsorption capability creates a chemical potential imbalance near the hydrogel compositions. This imbalance drives directional transport of vapor, enabling applications such as air-water harvesting, or thermal-humidity management. Notably, hydrogel compositions according to the disclosure distinguish themselves from prior art adsorbents due to their unique ability for self-regeneration under low ambient temperature (<65° C.) through direct sunlight or waste low-grade heat. The transparency and strong infrared absorption of the hydrogels enable direct solar-thermal evaporation for regeneration. Solar heating enables fast water expulsion, accelerating the regeneration process. The small size and micro-porous structure of adsorbent compositions according to the disclosure enhance water transport efficiency, facilitating fast and energy-efficient regeneration even at temperatures of about 65° C., far lower than required in zeolite-based systems (200° C.). Thanks to these distinctive features, system designs incorporating hydrogel compositions according to the disclosure can be significantly simplified compared to conventional adsorption-based systems. Hydrogels described herein are projected to achieve an unparalleled packaged energy density of over 1200 kJ/kg (or >330 Wh/kg). The calcium chloride loading in the testing subject, described below, is 60%. Considering the specific thermal energy storage capacity of pure calcium chloride is 2200 kJ/kg, the actual energy density of TCES adsorbents according to the disclosure aligns with the theoretical expectations, implying full retention of the energy efficiency of the thermochemical salt. For comparison, as of this filing, the energy density of the Tesla 4680 battery is 244-296 Wh/kg.

The development of adsorbent compositions according to various aspects of the disclosure involves several considerations, including the formulation of salt-compatible hydrogels, the creation of their structures, maintaining the integrity of these structures during volume changes, and ensuring their ability to regenerate. Hydrogels, with their remarkable water adsorption and wide range of choices of chemicals, are ideally suited for encapsulating various reactants, presenting them as viable alternatives to conventional hydrophilic mineral materials in energy applications like dehumidification, water harvesting, and environment control.

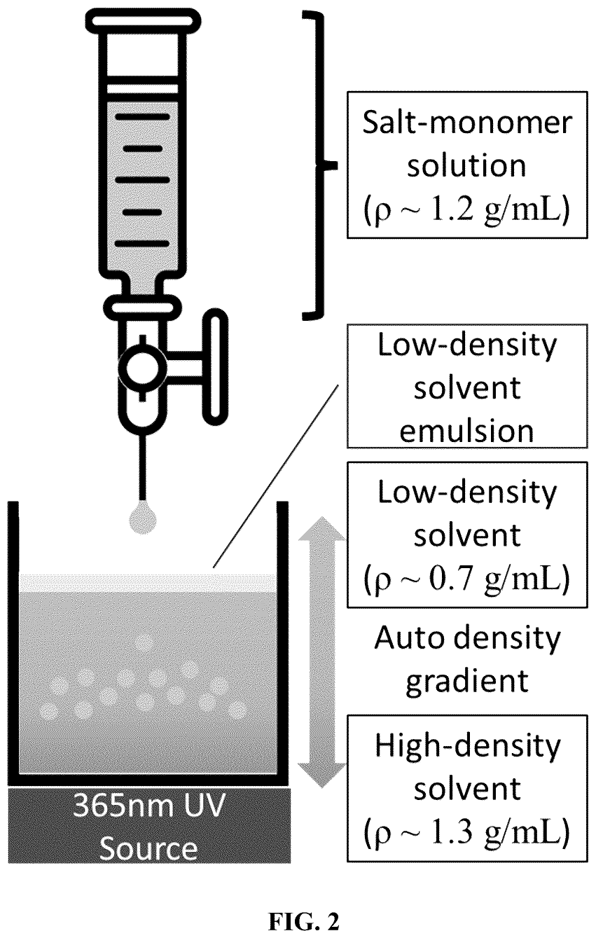

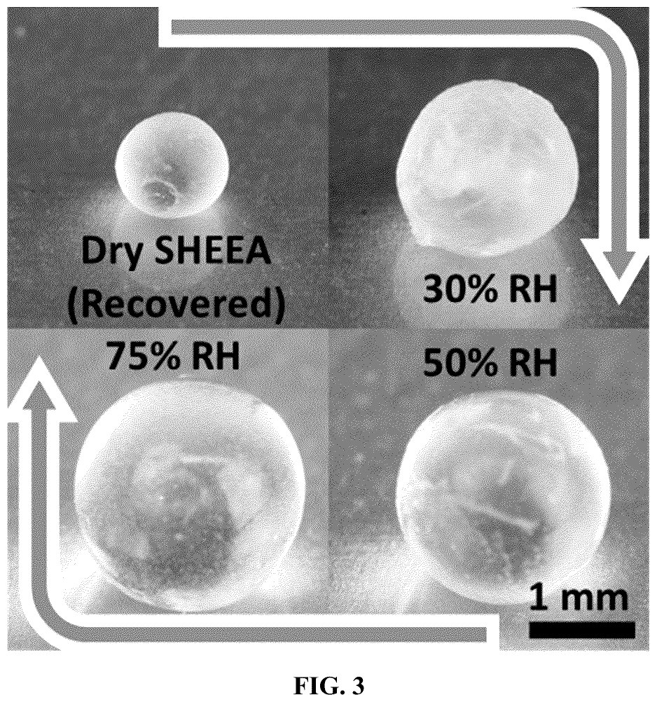

In the design of the adsorbent compositions and systems using the same described herein, hydrogel beads have been prepared as dry spheres of about 1 mm in diameter (FIGS. 2 and 3).

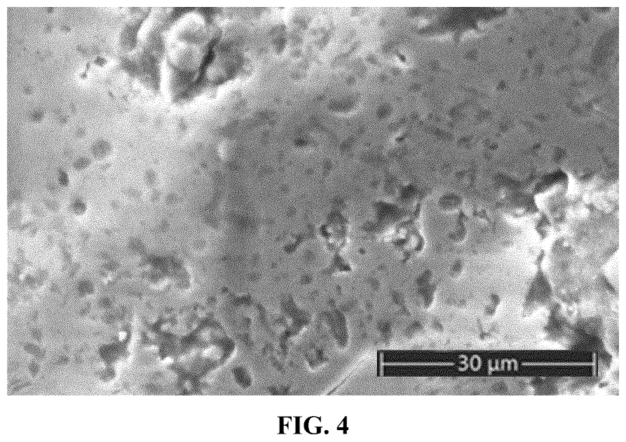

These dry hydrogel beads can then be packed within a water vapor adsorption chamber. It is important to note that the synthetic approach presented herein (as illustrated in, e.g., FIG. 2) circumvents the limitations of existing hydrogel beading methods, such as microfluidic-based beading and thermal-polymerized drop casting, which either are unsuitable for the bead sizes needed for specific thermal management applications or compromise the functionality of temperature-sensitive salts due to high temperatures. In some instances, adsorbent compositions according to the disclosure are prepared using a hydrogel beading protocol that uses a density-gradient suspension solution (FIG. 2), enabling casting of UV-cured hydrogel beads with a variety of polymer networks that boast high porosity and can accommodate a diverse range of salts regardless of density variations. This flexibility in material selection is key to adapting the hydrogels to specific environmental conditions and cooling/heating requirements. The fabrication of adsorbent composition beads with high porosity (FIGS. 3-4) is accomplished using a dual initiator polymerization system. This system merges a rapid-acting UV initiator with a slower initiator to produce a robust polymer network with excellent mechanical properties and potential fatigue resistance. This method has been proven to work effectively, as evidenced by the preparation of hydrogel precursors with high concentrations of TCES salts. consistently produces beads having desirably physical and chemical properties. Our approach ensures that beads will suspend in the middle of the suspension solvent without the need for complex solvent density adjustments, simplifying the production process and feasible for mass production in future manufacturing.

As discussed above, hydrogel beads according to various aspects of the disclosure are fabricated by drop-casting an aqueous hydrogel precursor solution into a multi-layer organic solvent suspension medium composed of multiple immiscible liquids. In some instances, the suspension medium consists of three liquid layers, each immiscible with water. Between layers, a transition layer will form by interdiffusion while the density difference is sufficient to keep them remain layered during the hydrogel beads fabrication process.

The upper liquid layer of the suspension medium comprises a suspension of surfactant-based micelles dispersed in an organic solvent with smaller or similar density as the second layer in the suspension medium such as a hydrocarbon solvent. Exemplary surfactants that may be used for such micelles formation include, but are not limited to polyethylene glycol tert-octylphenyl ether (for example Triton™ X-100), octylphenoxypolyethoxyethanol, (for example, Igepal® CA-630 and Nonidet P-40), polyethylene glycol sorbitan monolaurate (for example, Tween® 20). During the drop-casting process, a portion of these micelles migrates into the hydrogel precursor droplet due to solubility-driven chemical potential while the droplet falls through the initial layer.

Upon polymerization and subsequent drying, the internal organic solvent inside the micelles is removed, resulting in the formation of internal voids inside the hydrogel beads while the outer skin of the hydrogel beads remains solid. The porous interior facilitates rapid internal vapor transport, which governs both the energy release rate during hydration and the charging speed during dehydration. The denser outer surface layer functions as a containment skin that reduces salt leakage during repeated hydration-dehydration cycles. This skin-core architecture improves mechanical integrity, prolongs service life, and enhances cyclic stability under repeated thermal-chemical cycling.

The bottom two liquid layers of the suspension medium serve to keep the hydrogel beads suspended during polymerization. The use of density gradient suspensions overcomes a key difficulty for producing a suspension medium: it is impractical to make a suspension with a solution density matching exactly with the dispersed phase. Any slight difference will cause a dispersed phase to either float or sink, resulting in non-spherical hydrogel beads formation. For TCES material design, a regular shape not only guarantees the maximized surface area to volume ratio but also ensures high density packing when the material is loaded into thermal management systems such as an adsorption chamber. Multi-layer free-suspension method, the bottom two liquid layers are selected to have different densities, one being higher than the density of the hydrogel precursor solution and the other being lower. At the interface of these two layers of liquid, interfacial diffusion will naturally create a density transition zone in which there will exist an appropriate suspension density to allow free float of the hydrogel precursor droplet. This free-suspension condition prevents sedimentation, minimizes external deformation forces, and enables the formation of substantially spherical hydrogel beads without the use of molds, agitation, or mechanical confinement.

Within the suspension, the hydrogel polymerization process is initiated by light radiation, such as ultraviolet or visible light or heat, while the droplet remains suspended within the liquid medium. Polymerization under free-suspension conditions allows the hydrogel network to form uniformly throughout the droplet volume while maintaining spherical geometry and uniform bead size ranging from 1 mm to 3 mm.

This process enables the energy-storage salts (energy storage compounds) to be directly and homogeneously incorporated into the hydrogel precursor solution prior to polymerization regardless of its dissolution condition. The energy-storage salts may be present in a dissolved state, a supersaturated solution, or as a suspension of undissolved solid particles. Because the hydrogel precursor droplet is quickly polymerized while freely suspended, sedimentation of salt particles is minimized, and the polymer network forms uniformly around the salt species. This allows the hydrogel network to physically entrap the salt during curing, rather than relying on post-gelation diffusion. This approach enables salt loading levels substantially exceeding those achievable by conventional diffusion-based methods. In representative examples described elsewhere herein, calcium chloride is incorporated into a polyacrylamide hydrogel network at loadings of approximately 60-70 wt %, which is significantly higher than typical salt loadings achieved in diffusion-loaded hydrogels (~45 wt %).

The ability to form a hydrogel network around the dispersed salt (either in fully dissolved state or in an over saturated suspension state) ensures a tight encapsulation of the salt, benefiting the long-term stability of resulting TCSE hydrogel beads under cyclic working conditions. In addition, the drop-casting process further enables controlled bead size and narrowed size distribution.

### EXAMPLES

As a technology demonstration, based on the proposed fabrication technique as well as the material systems, a CaCl₂)-incorporated polyacrylamide TCES adsorbent, in the form of beads, is synthesized and detailed characterization is performed. The synthesis process involves using drop casting with radical polymerizing of monomers (acrylamide or similar), crosslinkers (bis-acrylamide or similar) with UV initiators such as I-2959. The thermochemical salt encapsulated hydrogel polymer network composition can be tuned between 0.5 to 1 M for monomer concentration and from 25:1 to 200:1 for monomer:crosslinker concentration. The amount of salt (calcium chloride) incorporated in the precursor solution is limited by its solubility. Depending on the monomer concentration, the total incorporated salt (calcium chloride) can vary.

### Example 1

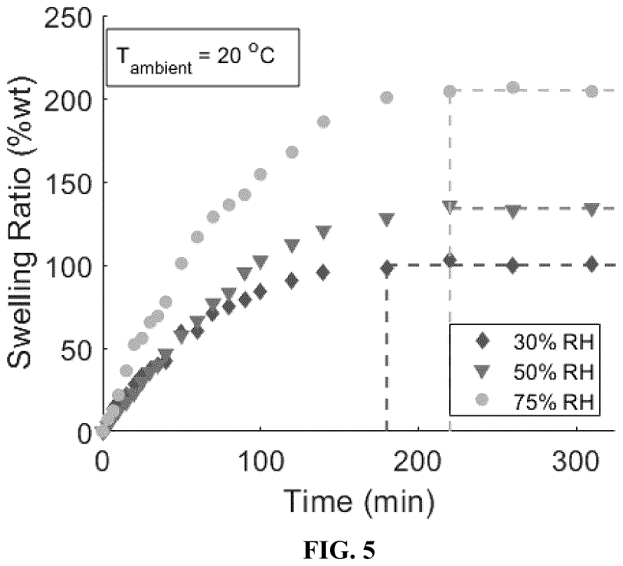

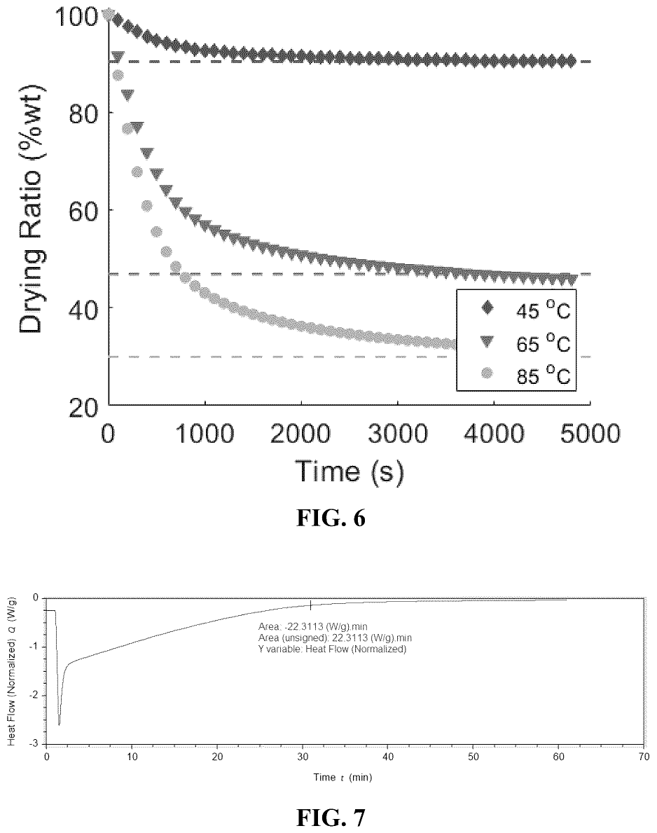

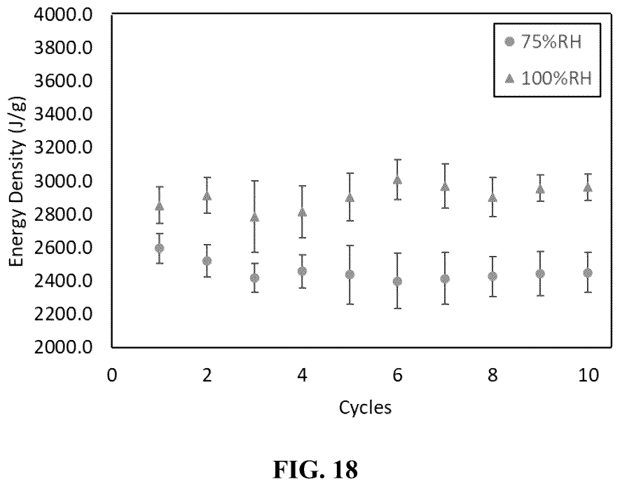

In this example, a 35 g calcium chloride is dissolved in a solution having a total monomer concentration of about 1.5M and 100:1 monomer:crosslinker ratio to form a salt-monomer precursor solution. The UV polymerization initiator is then added in an amount of 2 mg/mL of the precursor solution. The precursor solution is prepared to have a density ranging from about 1.2 to 1.25 g/mL. To create the density gradient suspension into which the precursor solution were added dropwise, a pair of water immiscible but inter-miscible solvents is used. The solvent pair must have densities above and below 1.25 g/mL. In this example, dichloromethane (DCM, 1.33 g/mL) and mineral spirit (0.79 g/mL) were selected as the solvent pair. To further enhance the droplet stability, a small amount of surfactant (0.1%-0.5% vol. e.g., SPAN 80) was added to the mineral spirit. The DCM was first added to a beaker and an equivalent amount of mineral spirit (with SPAN 80) was then slowly added on top of the DCM without agitation or stirring. Due to the mixing of DCM and mineral spirit at an layer interface, an intermediate density layer forms, allowing precursor droplets to suspend during photopolymerization. After polymerization, the hydrogel beads were extracted from the suspension using a slotted spoon and dried in a ventilated oven at 80° C. The dried hydrogel beads exhibited a maximum salt loading of 80% by weight. This significantly surpasses the less than 20% typically seen in prior art porous mineral-based TCES. The adsorbent composition's thermal performance is also noteworthy. Controlled testing, including DSC scanning, showed the adsorbent composition beads formed in this example could absorb water vapor at varying humidity levels, gaining up to 210% in weight and storing an impressive energy density of 1200 kJ/kg. (FIG. 5). These results affirm the real-world applicability of adsorbent compositions according to the disclosure. Additionally, the process of regenerating the hydrogel beads is efficient (FIG. 6), with >80% recovery possible within one hour at 65° C., a temperature easily achievable with solar heat. This temperature requirement is significantly lower than the >200° C. needed for current state-of-the-art TCES materials. The regeneration DSC scan also demonstrated efficient regeneration and energy storage at a temperature of 65° C. (FIG. 7) Later the cyclic testing on DSC also demonstrated stable operation-regeneration of the adsorbent composition beads prototype over 10 cycles (FIG. 18).

The adsorbent composition technologies of the disclosure embody a leap in thermal energy storage and release, setting a new benchmark for innovation in the field. In accordance with various aspects of the disclosure, adsorbent compositions can be prepared such that they exhibit salt loading capacity of 80% by weight far exceeds the less than 20% offered by traditional porous mineral-encapsulated adsorbents, heralding a new era of energy density. In some instances, adsorbent compositions according to the disclosure demonstrate energy storages exceeding 1200 kJ/kg.

### Example 2

In this example, various hydrogel beads were produced from different salt-monomer precursor solutions using the same protocol as described in Example 1, and were characterized with respect to internal pore formation, pore structure, salt distribution, water vapor transport properties, energy storage density, and cyclic stability. Performance measurements demonstrate enhanced energy density, improved transport kinetics, and stable performance over multiple charging and discharging cycles compared to conventional salt-loaded hydrogel materials. The different salt-monomer precursor solutions used for the preparation of TCSE hydrogel beads are summarized in Table 1, below.

TABLE 1

| | | Bis- | | | | |
|---|---|---|---|---|---|---|
| | Acryl- | Acryl- | | | | |
| Precursor | amide | amide | HEMA | AMPS | I-2959 | CaCl₂ |
| Solution | (mol/L) | (mol/L) | (mol/L) | (mol/L) | (mol/L) | (wt %) |
| S1 | 1 | 0.02 | 0 | 0 | 0.02 | 30 |
| S2 | 1 | 0.02 | 0 | 0 | 0.02 | 35 |
| S3 | 1 | 0.02 | 0 | 0 | 0.02 | 40 |
| S4 | 1 | 0.04 | 0 | 0 | 0.02 | 40 |
| S5 | 0.8 | 0.02 | 0.2 | 0 | 0.02 | 40 |
| S6 | 0.8 | 0.02 | 0 | 0.2 | 0.02 | 40 |

Thermogravimetric analysis (TGA) was employed to quantify the salt content within the hydrogel beads. In this method, prepared hydrogel beads were first subjected to drying under various regeneration conditions designed to simulate practical operating environments for thermal-chemical energy storage applications. Following regeneration, the samples were heated to temperatures sufficient to decompose the polymeric hydrogel matrix, thereby removing organic components and enabling gravimetric determination of the residual inorganic salt content.

Weight change during heating was recorded using a thermal analysis system (Mettler Toledo TGA 2). Fully hydrated hydrogel beads prepared using representative compositions (S1, S2, and S3) were initially regenerated at temperatures ranging from approximately 40° C. to 100° C. under a constant air purge flow rate of 1 mL/min until mass stabilization was observed. After regeneration, the samples were heated to approximately 650° C. and held at that temperature for 10 minutes, with the purge flow rate maintained, to ensure complete decomposition of the polymer network. Due to the low chemical potential of water in the thermal-chemical energy storage (TCES) hydrogel system and the high thermal stability of hydrated calcium chloride species, complete removal of water from the hydrogel beads is challenging under practical regeneration conditions. Even after drying at elevated temperatures, a substantial amount of water may remain bound within the hydrogel in the form of coordinated or chemically associated water with calcium chloride.

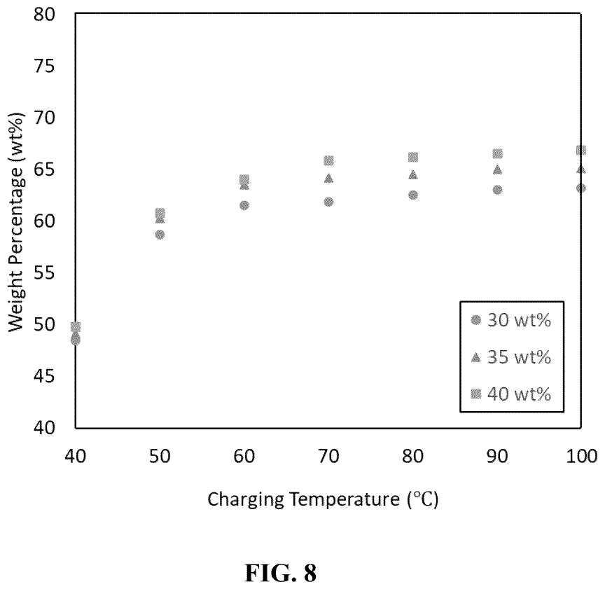

As a result, although the theoretical maximum calcium chloride loading for composition S3 may reach approximately 86.9 wt % in a fully anhydrous state, the experimentally achievable salt loading under realistic regeneration conditions is lower. Specifically, the effective salt content is limited to below approximately 70 wt % following regeneration at temperatures relevant to practical system operation (see, e.g., FIG. 8). It is noted that certain hydrated forms of calcium chloride, such as calcium chloride tetrahydrate, undergo dehydration at temperatures near 45° C. Once the regeneration temperature exceeds this threshold, further increases in regeneration temperature provide diminishing returns in terms of increasing final salt loading density. This behavior indicates that the disclosed TCSE hydrogel system can achieve high salt loading and energy storage performance while operating at relatively low regeneration temperatures. Thermogravimetric analysis confirms that regenerated TCES hydrogel beads consistently retain calcium chloride loadings of up to approximately 67 wt % when regenerated at temperatures in the range of approximately 70° C. to 100° C., demonstrating the effectiveness of the disclosed fabrication and material composition strategy.

Following thermogravimetric analysis of salt content, the thermal-chemical energy storage (TCES) hydrogel beads were subjected to hydration (discharging) testing to characterize their water vapor adsorption kinetics. These experiments were conducted to evaluate the rate and extent of water vapor uptake under controlled environmental conditions representative of practical TCES operation.

The hydration testing was performed by placing regenerated hydrogel beads in a laboratory-built chamber with independently controlled temperature and relative humidity. The mass of the hydrogel beads was monitored continuously over time until an equilibrium mass was reached, allowing quantification of both adsorption kinetics and equilibrium water uptake.

A first set of experiments was conducted using hydrogel beads prepared with representative composition S3 to evaluate the influence of environmental temperature and relative humidity on water vapor adsorption behavior. Water vapor was supplied to the hydrogel beads at temperatures of approximately 20° C., 30° C., and 40° C., and at relative humidity levels of approximately 25%, 50%, 75%, and 100%. These temperature and humidity ranges correspond to typical operating conditions of TCES systems in building thermal management applications. In representative implementations, the TCES system initiates discharging near ambient temperature and equilibrates at temperatures in the range of approximately 35-40° C. during the hydration process to achieve high energy release efficiency.

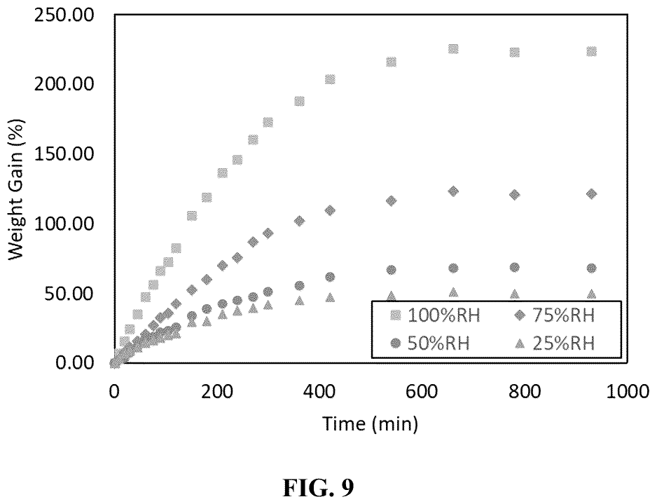

FIG. 9 illustrates the adsorption kinetics of the S3 hydrogel beads at approximately 40° C. under relative humidity conditions ranging from 25% to 100%. Under 100% relative humidity, the hydrogel beads exhibited a maximum mass increase of approximately 225% relative to their initial regenerated mass. This behavior is attributed to the dependence of water vapor chemical potential on relative humidity. At higher relative humidity, the chemical potential of water vapor is increased, which enhances both the diffusion rate of water into the hydrogel beads and the equilibrium degree of hydration. In addition, higher vapor concentrations at elevated relative humidity led to a greater equilibrium swelling state of the hydrogel beads.

The equilibrium swelling ratio of the TCSE hydrogel beads directly influences the total releasable energy during the discharging process. A significant portion of the energy released arises from condensation heat associated with water vapor driven by differences in chemical potential. As a result, the total energy output of the TCES system is a function of the humidity conditions of the discharging environment. One can characterize this energy output by characterizing the energy in take during a charging cycle of the correspondingly hydrated TCSE hydrogel beads due to energy conservation. This is measured by differential scanning calorimetry (DSC) under 80° C. conditions, and the energy flux is integrated over time to obtain the total energy intake. For each case, the energy density measured for 25-100% RH discharging conditions were 959±56 J/g (25% RH), 1350±79 J/g (50% RH), 2427±95 J/g (75% RH), and 2961±123 J/g (100% RH), respectively. These results demonstrate that the disclosed TCSE hydrogel material can effectively leverage ambient humidity to achieve high energy release under conditions relevant to real-world HVAC and building thermal management systems.

Additional hydration experiments were conducted at a fixed relative humidity of approximately 75% while varying the temperature between approximately 20° C. and 40° C. Because relative humidity represents the ratio of the actual water vapor partial pressure to the saturation vapor pressure at a given temperature, the absolute water vapor concentration varies significantly with temperature even at constant relative humidity. For example, as temperature decreases from approximately 40° C. to 20° C., the saturation vapor pressure of water decreases from approximately 55.3 mmHg to approximately 17.5 mmHg. Consequently, at 75% relative humidity, the absolute water vapor concentration at 20° C. is only approximately 31% of that at 40° C.

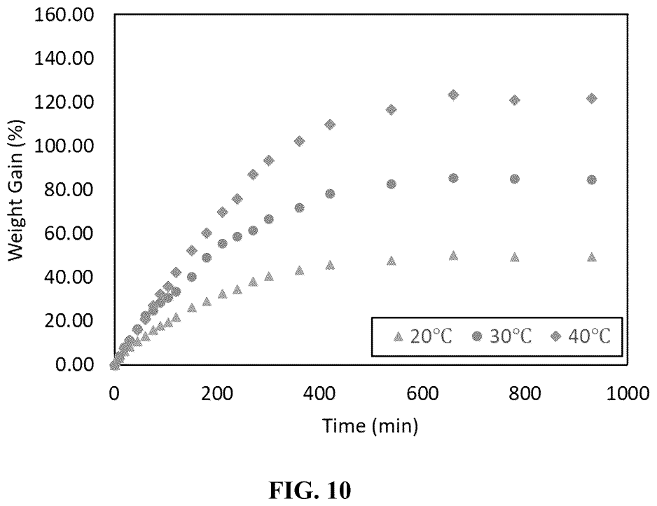

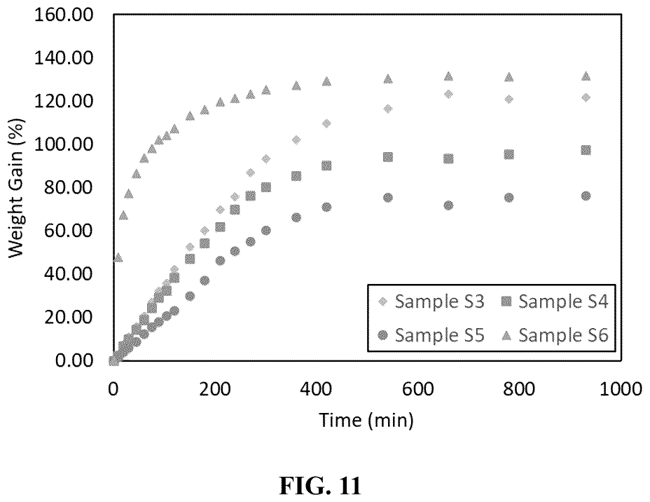

FIG. 10 illustrates the resulting adsorption behavior of the TCSE hydrogel beads under these conditions, demonstrating reduced adsorption kinetics and equilibrium uptake at lower temperatures due to the decreased water vapor availability. Using a similar DSC measurement, the energy density measured for 20-40° C. discharging conditions are 679±73 J/g (20° C.), 1158±107 J/g (30° C.), and 2427±95 J/g (40° C.), respectively.

In addition to environmental conditions, the polymer composition and internal network structure of the hydrogel beads significantly influence water vapor adsorption behavior and energy release performance. In the disclosed TCSE hydrogel system, the polymer composition is highly tunable based on the selected gelation mechanism, enabling the material properties to be tailored for specific energy storage and release requirements.

The encapsulating polymer network may be selected and engineered to achieve a desired energy releasing rate during the discharging (hydration) process. In general, the hydrophilicity of the polymer network is a primary factor governing the diffusion rate of water vapor into the hydrogel beads. Increased network hydrophilicity facilitates faster water uptake and higher diffusion rates, which in turn accelerates energy release during discharging.

In addition to monomer chemistry, the crosslinking density of the hydrogel network plays an important role in determining the equilibrium swelling behavior of the TCSE hydrogel beads. Crosslinking density influences network elasticity, which controls the extent to which the hydrogel can swell upon hydration. Higher crosslinking densities restrict excessive hydrogel swelling by increasing network stiffness. While such restrictions can reduce the total water intake and, consequently, the maximum achievable energy density, they may be advantageous in practical system configurations. In particular, limiting excessive swelling can prevent mechanical deformation, structural instability, or clogging of vapor transport pathways caused by overly expanded hydrogel beads in confined or packed-bed configurations.

Examples of suitable polymer compositions are provided in Table 2, organized from highly hydrophilic to relatively hydrophobic monomer candidates. These examples illustrate the tunability of adsorption kinetics and equilibrium swelling behavior through polymer selection. The monomer choices are not limited to the listed examples. The monomer(s) may be selected based on one or both of their density and water solubility. Any water-soluble monomer or monomer combination having a combined solubility (defined as total monomer concentration regardless of their type or mixture composition/ratio) equal or greater than 1 mol/L and capable of forming a polymer network with the assistance of a crosslinker molecule with greater or equal to 0.01 mol/L solubility may be employed. While the final solution density should be smaller than 1.36 g/mL for a proper suspension in some instances, monomer selections are normally not a limiting factor as they only exist in low concentration state. The density of the salt-monomer precursor solution is dominated by energy storage salt concentration.

TABLE 2

| | Hydrophilicity |
|---|---|
| SHETA Hydrogel Monomer | Index (Log P) |
| 2-Acrylamido-2-Methyl Propane Sulfonic | −1.21 |
| Acid | |
| Acrylamide | −0.9 |
| n-Hydroxyethyl Acrylamide | −0.56 |
| Methacrylamide | 0.08 |
| 2-Hydroxyethyl Acrylate | 0.12 |
| Hydroxyethyl Methacrylate | 0.47 |
| Methyl Acrylate | 0.64 |
| t-Butyl Acrylamide | 0.84 |

For illustrative purposes, representative hydrogel samples S3 through S6 were prepared to demonstrate the influence of polymer composition and network structure on TCES performance. Sample S3 serves as a reference system. Sample S4 represents a hydrogel network with increased crosslinking density, resulting in reduced water intake. Sample S5 represents a more hydrophobic polymer network, leading to both reduced water uptake and reduced diffusion rates. Sample S6 represents a highly hydrophilic polymer network designed to enhance water intake and diffusion kinetics.

All samples were evaluated under identical adsorption conditions of approximately 75% relative humidity at 40° C. Using DSC measurements under charging conditions, the measured energy densities for samples S3 through S6 were approximately 2427±95 J/g (S3), 1786±108 J/g (S4), 1462±75 J/g (S5), and 2530±92 J/g (S6), respectively. These results demonstrate that polymer composition and network structure provide effective design parameters for tailoring adsorption kinetics, equilibrium swelling, and energy density of the TCSE hydrogel beads to meet specific application requirements.

In addition to chemical composition, the geometry and internal microstructure of the hydrogel beads play a significant role in determining the performance of the TCSE hydrogel. A key feature of the disclosed invention is the presence of internal porosity within the hydrogel beads, which enhances mass transport and accelerates water vapor adsorption during the discharging (hydration) cycle.

The internal porosity of the hydrogel beads is generated during fabrication through the incorporation of surfactant micelles originating from the upper layer of the multi-layer density-gradient suspension medium. During polymerization of the hydrogel precursor droplet, these micelles embed within the polymer network. Following curing and subsequent processing, the micelles are removed or collapsed, leaving behind voids distributed throughout the hydrogel interior.

This internal microstructure of the hydrogel beads was examined using scanning electron microscopy (SEM) to confirm the presence of internal porosity. Calcium distribution within the hydrogel beads was further characterized by using energy-dispersive X-ray spectroscopy (EDS). FIGS. 5 and 12 compare the internal microstructure of hydrogel beads prepared with representative composition S3 using suspension media either including or excluding the surfactant-containing top layer. Hydrogel beads fabricated using a simplified two-layer density-gradient suspension, without the top micelle-containing layer, has a non-porous internal structure. In contrast, beads fabricated using the full multi-layer suspension medium exhibited pronounced internal porosity. These observations confirm the necessity of the surfactant-containing top suspension layer for internal porosity formation in the disclosed TCSE hydrogel beads.

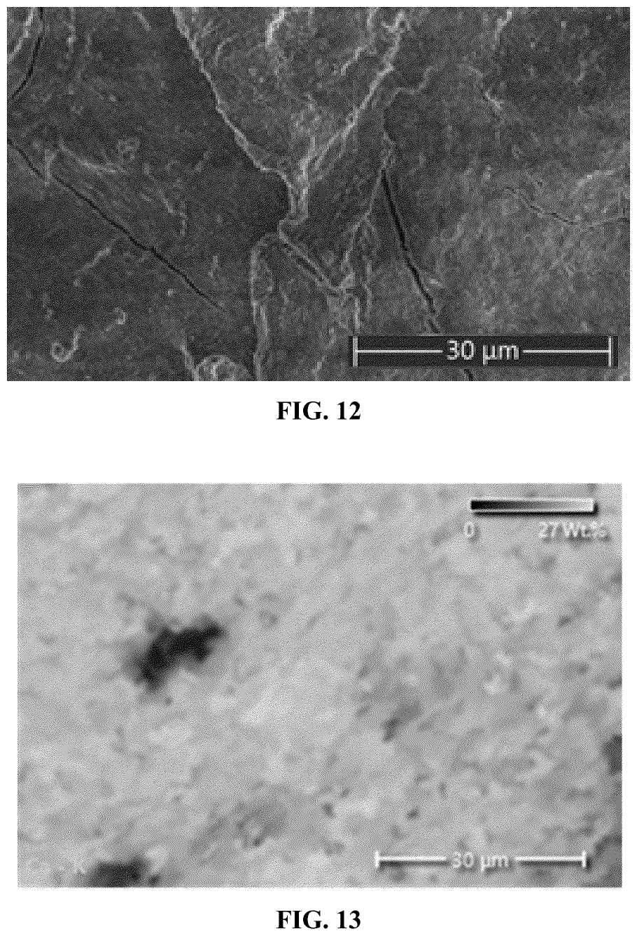

FIG. 13 is an EDS scan of a cross-section of a representative hydrogel beads, demonstrating a substantially uniform distribution of calcium chloride throughout the polymer network. This uniform salt distribution indicates effective encapsulation of the energy-storage salt during polymerization and supports consistent adsorption behavior throughout the bead volume.

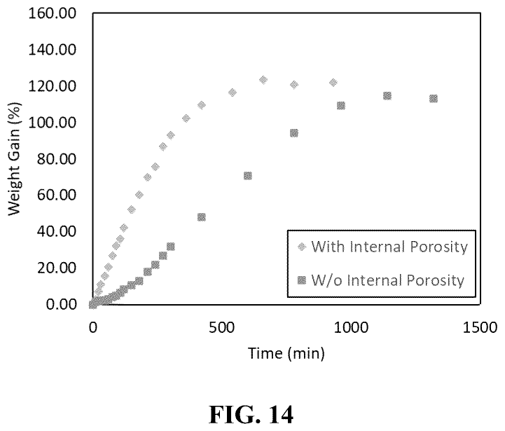

The water vapor adsorption kinetics of porous and non-porous hydrogel beads were compared under identical discharging conditions using the previously described testing setup at approximately 75% relative humidity and 40° C. The internally porous TCSE hydrogel beads exhibited a noticeably faster adsorption rate than the non-porous counterparts. This enhanced adsorption performance is attributed to the increased effective diffusivity provided by the internal porosity, which facilitates rapid water vapor transport into the interior of the hydrogel beads. The results demonstrate that internal porosity serves as a critical structural feature for improving mass transport efficiency and accelerating energy release during TCES discharging cycles (FIG. 14). Using DSC measurements under charging conditions, the measured energy densities for both samples under S3 composition were very similar despite the difference in kinetics with the porous one being 2427±95 J/g and non-porous one being 2205±146 J/g.

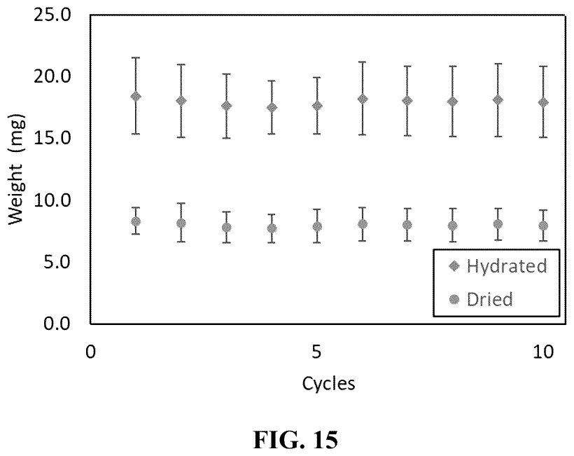

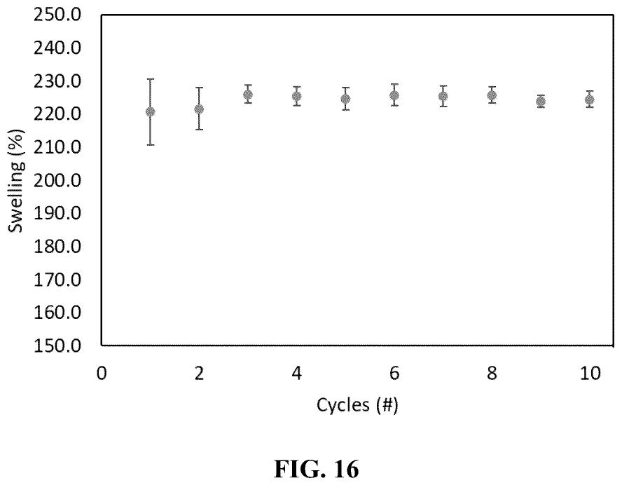

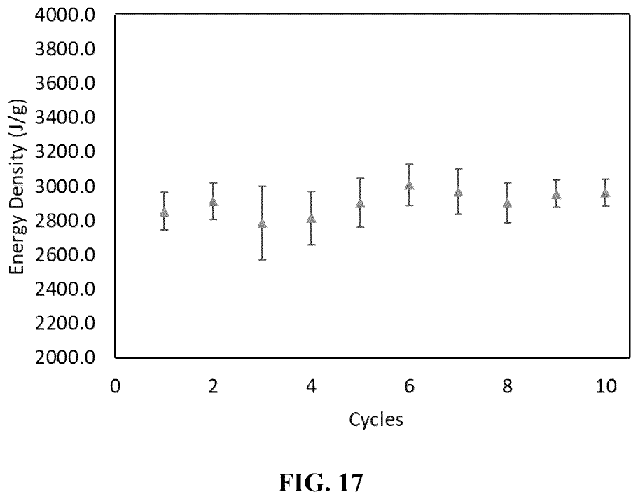

Following the parametric study on the TCSE hydrogel beads' performance, the material cyclic performances were evaluated. The hydrogel beads were subjected to repeated charging and discharging cycles for 10 times. The discharging was performed at 100% RH at 40° C. The charging was performed at 80° C. until equilibrium. FIG. 15 shows the weight of the sample S3 after fully charging (Dried, lower data point set), and after fully discharging (Hydrated, upper data point set). FIG. 16 shows the weight gain of the sample S3 under each cycle measured and calculated from FIG. 15 results. Using DSC, energy density change of the TCSE hydrogel beads over cycles can be measured (FIG. 17). As can be seen in FIG. 17, the material exhibits good stability over 10 cycles. This performance evidences the superiority of TCSE hydrogel beads according to the present disclosure relative to previously reported hydrogel TCES systems, which often exhibit thermal fatigue within 5 cycles. FIG. 18 compares the energy density of the sample S3 when cycled under different humidities: 75% RH and 100% RH. The stability is all very good over cycles.

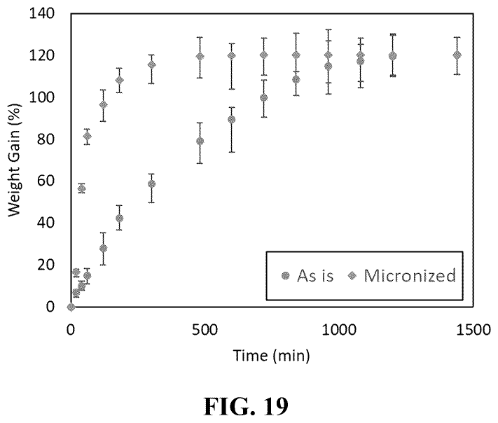

In another test, the sample S3 was incorporated into a scaled AC cooling-heating system. The testing results have shown similar thermal energy density. In this test, the hydrogel beads as prepared (sizes of 1-3 mm) and in micronized form (sizes of 100-200 μm, by grinding the as-prepared hydrogel beads) were compared for absorption amount and rate. As can be seen in FIG. 19, micronized hydrogel exhibited a substantially faster adsorption rate.

One of the most significant breakthroughs of the adsorbent compositions disclosed herein are their ability to regenerate at relatively low temperatures. This property effectively eliminates the need for a heating system and vapor compression system for regeneration, resulting in a significant increase in the energy density of the entire system. The innovative edge of the adsorbent compositions disclosed herein is further sharpened by their exceptional performance in adverse conditions. Their strong moisture capture ability and extremely high water intake set a high bar for energy density and longevity, making them a robust solution across diverse applications. This feature addresses one of the most restrictive factors in the thermochemical energy storage field, opening doors to highly scalable environmental management or water harvesting systems. The double network polymer system within the adsorbent compositions disclosed herein provides unmatched structural integrity, enabling a controllable and consistent release of stored energy. The ingenuity of the adsorbent compositions' design enhances the surface-to-volume ratio, which significantly boosts heat transfer while concurrently prevents recrystallization. This feature, coupled with the adsorbent compositions' high cyclic life, speaks to the durability and reliability of the material. The adsorbent compositions disclosed herein also have malleable fabrication potentials, unlike mineral-based systems that are limited in form and composition. As described elsewhere herein, a unique beading protocol has been developed for the preparation of adsorbent compositions according to various aspect of the disclosure, involving a density-gradient suspension solution. This methodology allows for the creation of photo-cured hydrogel beads that are highly porous and capable of versatile salt loading. The photo-polymerization process provides greater flexibility in material selection, enabling various monomers to be copolymerized. This versatility allows for the tuning of the hydrogel's hygroscopic properties, which in turn makes it possible to adjust the water vapor intake rate of the adsorbent compositions according to specific design specifications, local temperature, humidity, and required cooling capacities. Systems incorporating adsorbent compositions according to the disclosure can operate without an external water supply. The adsorbent compositions' ability to regenerate without a heating circuit or vapor compressor boasts an operating electrical consumption that is virtually free, marking a substantial stride toward sustainability. The use of water in a closed loop for heat pumping underscores the low environmental impact of systems according to the disclosure, as they can operate without the need for harmful refrigerants.

The systems described herein represent a significant stride in sustainable technology. They challenge the traditional paradigms of thermal management, humidity management as well as air water generation by employing a high energy density and easily regenerating thermochemical energy storage medium that can operate without primary energy source such as electricity or fossil fuel. This innovation is not just a standalone feature; it is the cornerstone of a broader impact on several fronts: (1) Environmental Impact: Traditional environmental regulation and water harvesting systems contribute to global warming through greenhouse gas emissions. The systems described herein, however, operate without these pollutants, positioning them as eco-friendly alternatives. (2) Energy Efficiency: By avoiding the use of refrigerant heat pump or resistive heating element, the systems described herein minimize electricity consumption, offering a cost-effective energy source. (3) Water Harvesting and Purification: The passive cooling technology can be leveraged in water-scarce regions to condense and collect water vapor from the air. (4) Miniaturization Potential: The prospect of miniaturizing this technology opens avenues in electronics, where overheating is a common issue, thus benefiting sectors such as aerospace and automotive with advanced thermal management systems. (5) Advanced Refrigeration: By exploring alternative reactants, thermochemical reactions of the systems described herein can be customized for specialized refrigeration applications or even for the treatment of waste gases, showcasing its adaptability and potential in industrial applications. (6) Economic Impact: The cost-effectiveness, simple and robust construction, and low operational costs of the systems described herein not only make them accessible to low and medium income households but could also stimulate economic activity by reducing energy expenditures and potentially creating new markets and job opportunities in sustainable technology sectors.

While certain implementations have been described in terms of what may be considered to be specific aspects, the present disclosure is not limited to the disclosed aspects. Additional modifications and improvements to the aforementioned vial adapter may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

What is claimed is:

1. An adsorbent composition comprising:
a porous hydrogel; and
one or more energy storage compounds contained within the hydrogel,
wherein the one or more energy storage compounds are at least 50 wt % of the adsorbent composition on a dry weight basis.

2. The adsorbent composition of claim 1, wherein the one or more energy storage compounds are 60 to 90 wt % of the adsorbent composition on a dry weight basis.

3. The adsorbent composition of claim 1, wherein the adsorbent composition is in a hydrated form.

4. The adsorbent composition of claim 1, wherein the adsorbent composition is convertible to a dehydrated form by heating at a temperature of less than 200° C.

5. The adsorbent composition of claim 1, wherein the adsorbent composition is convertible to a dehydrated form by heating at a temperature of less than 100° C.

6. The adsorbent composition of claim 1, further comprising a nonporous outer hydrogel shell encapsulating the porous hydrogel.

7. The adsorbent composition of claim 1, wherein the one or more energy storage compounds comprise a salt.

8. The adsorbent composition of claim 7, wherein the salt is a chloride salt, a bromide salt, a sulfate salt, a nitrate salt, or an acetate salt.

9. The adsorbent composition of claim 1, wherein the porous hydrogel is a natural hydrogel.

10. The adsorbent composition of claim 1, wherein the porous hydrogel is a synthetic hydrogel.

11. The adsorbent composition of claim 1, wherein the adsorbent composition has an aspect ratio ranging from about 1 to about 2.

12. A thermochemical adsorption cooling system (TACS) comprising an adsorbent composition according to claim 1.

13. A thermochemical energy storage (TCES) system comprising an adsorbent composition according to claim 1.

14. A method of making an adsorbent composition comprising:
preparing an adsorbent precursor solution comprising one or more hydrogel precursors and one or more energy storage compounds;
drop casting the adsorbent precursor solution into a density gradient suspension to form adsorbent precursor solution beads suspended therein; and
polymerizing the suspended adsorbent precursor solution beads to form the adsorbent composition.

15. The method of claim 14, wherein the adsorbent precursor solution is further prepared with a crosslinker.

16. The method of claim 14, wherein the adsorbent precursor solution is prepared to have a density ranging from about 1.2 to 1.25 g/mL.

17. The method of claim 14, wherein the polymerization is initiated by light, heat, or redox reactions.

18. The method of claim 14, wherein the density gradient suspension has a density gradient ranging from about 0.7 g/ml to about 1.4 g/ml.

19. The method of claim 14, wherein the density gradient suspension comprises surfactant-based micelles.

20. The method of claim 19, further comprising removing surfactant-based micelles from the adsorbent composition.
